(19) United States
(12) Patent Application Publication
(10) Pub. No.: US 2026/0291357 A1
(43) Pub. Date: Sep. 24, 2026

(54) CAMERA MODULE

(71) Applicant: Samsung Electro-Mechanics Co., Ltd., Suwon-si (KR)

(72) Inventors: Young Bok YOON, Suwon-si (KR); Chuel Jin PARK, Suwon-si (KR); Bo Sung SEO, Suwon-si (KR); Ki Ho LEE, Suwon-si (KR); Soo Cheol LIM, Suwon-si (KR)

(73) Assignee: Samsung Electro-Mechanics Co., Ltd., Suwon-si (KR)

(21) Appl. No.: 19/539,117

(22) Filed: Feb. 13, 2026

(30) Foreign Application Priority Data
Mar. 21, 2025 (KR) 10-2025-0036835
Jul. 24, 2025 (KR) 10-2025-0100814

(51) Int. Cl. H02K 41/035; G02B 27/64; H04N 23/54; H04N 23/57

(52) U.S. Cl. CPC H02K 41/0356; G02B 27/646; H04N 23/54; H04N 23/57

(57) ABSTRACT

A camera module is provided. The camera module includes a housing; a carrier, accommodated in the housing, and configured to move in an optical axis direction; and a first guide portion and a second guide portion respectively disposed between the housing and the carrier, and spaced apart from each other in a diagonal direction of the carrier, wherein the first guide portion is disposed on any one of the carrier and the housing and includes a plurality of first protrusions that are spaced apart from each other in the optical axis direction, wherein the second guide portion includes at least one second protrusion that is disposed on any one of the carrier and the housing, and wherein sliding friction occurs on the plurality of first protrusions based on a movement of the carrier.

### CROSS-REFERENCE TO RELATED APPLICATIONS

This application claims the benefit under 35 USC §119(a) of Korean Patent Application No. 10-2025-0036835 filed on Mar. 21, 2025, and Korean Patent Application No. 10-2025-0100814 filed on Jul. 24, 2025, in the Korean Intellectual Property Office, the entire disclosures of which are incorporated herein by reference for all purposes.

### BACKGROUND

### 1. Field

The following description relates to a camera module.

### 2. Description of Related Art

Camera modules have been implemented in mobile communication terminals such as, but not limited to, smartphones, tablet personal computers (PCs), and laptop PCs. The camera modules may include an actuator having a focus adjustment operation to generate a high-resolution image.

A thickness, or form factor, of the mobile communication terminal has gradually become smaller or thinner, and accordingly, it is necessary to reduce a thickness of the camera module.

However, due to several factors for capturing the high-resolution image, it is difficult to reduce the thickness of the camera module.

In particular, when a lens module is supported by a plurality of balls performing rolling movement in an optical axis direction of the lens module, if the thickness of the camera module is reduced, a support region supported by the plurality of balls may be reduced, which may cause the lens module to tilt during the movement of the lens module, thereby adversely affecting performance of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing; a carrier, accommodated in the housing, and configured to move in an optical axis direction; and a first guide portion and a second guide portion respectively disposed between the housing and the carrier, and spaced apart from each other in a diagonal direction of the carrier, wherein the first guide portion is disposed on any one of the carrier and the housing, and comprises a plurality of first protrusions that are spaced apart from each other in the optical axis direction, wherein the second guide portion comprises at least one second protrusion that is disposed on any one of the carrier and the housing, and wherein sliding friction occurs on the plurality of first protrusions as the carrier moves.

Sliding friction may occur on the at least one second protrusion as the carrier moves.

The first guide portion may further include a first guide groove that is disposed in another of the carrier and the housing, and wherein each of the plurality of first protrusions may be in two-point contact with the first guide groove.

A guide plate made of a metal material may be disposed in the first guide groove, and each of the plurality of first protrusions may be in two-point contact with the guide plate.

The second guide portion may further include a second guide groove that is disposed in another of the carrier and the housing, and the at least one second protrusion may be in one-point contact with the second guide groove.

The first guide portion may further include a shaft that is disposed on another of the carrier and the housing, and the shaft may be in contact with the plurality of first protrusions.

A guide plate made of a metal material may be disposed on a surface of each of the plurality of first protrusions, and the shaft may be in contact with the guide plate.

The plurality of first protrusions may be bonded to any one of the carrier and the housing.

The camera module may further include a first driving unit including a first magnet disposed on a first side surface of the carrier and a first coil disposed to face the first magnet, and a first yoke disposed to face the first magnet, wherein the first yoke may be disposed closer to the first guide portion than to the second guide portion.

The plurality of first protrusions may protrude from one corner of the carrier, and the at least one second protrusion may protrude from a second side surface of the carrier adjacent to the first side surface of the carrier.

The camera module may further include a first driving unit configured to move the carrier in the optical axis direction, wherein the first driving unit may include a first sub-magnet disposed on a first side surface of the carrier; a second sub-magnet disposed on a second side surface of the carrier, which is spaced apart from the first side surface of the carrier in a first direction perpendicular to the optical axis direction; a first sub-coil disposed to face the first sub-magnet; and a second sub-coil disposed to face the second sub-magnet.

The camera module may further include a first sub-yoke disposed to face the first sub-magnet; and a second sub-yoke disposed to face the second sub-magnet.

A center of the first sub-magnet may be disposed closer to the first guide portion than to a center of the first side surface of the carrier, and a center of the second sub-magnet may be disposed closer to the second guide portion than to a center of a second side surface of the carrier.

The center of the first sub-magnet and the center of the second sub-magnet may be spaced apart from each other in a second direction perpendicular to both the optical axis direction and the first direction.

The plurality of first protrusions may protrude from the first side surface of the carrier, and the at least one second protrusion may protrude from the second side surface of the carrier.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a schematic exploded perspective view of the example camera module, in accordance with one or more embodiments.

FIG. 3 illustrates a perspective view illustrating an example in which a lens module and a carrier are separated from a housing in the example camera module, in accordance with one or more embodiments.

FIG. 4 illustrates a perspective view of the components illustrated in FIG. 3 viewed from another direction.

FIG. 5 illustrates a plan view of an example in which a case is removed from the example camera module, in accordance with one or more embodiments.

FIG. 6 illustrates an enlarged view of portion A of FIG. 5.

FIG. 7 illustrates an enlarged view of portion B of FIG. 5.

FIG. 8 illustrates a cross-sectional view taken along line I-I' of FIG. 1.

FIG. 9 is a view illustrating a first modified example of a first guide portion included in the example camera module, in accordance with one or more embodiments.

FIGS. 10 and 11 are views illustrating a second modified example of the first guide portion included in the example camera module, in accordance with one or more embodiments.

FIGS. 12-14 are views illustrating a third modified example of the first guide portion included in the example camera module, in accordance with one or more embodiments.

FIG. 15 illustrates a perspective view of a guide frame included in the example camera module, in accordance with one or more embodiments.

FIG. 16 illustrates a plan view of the guide frame illustrated in FIG. 15.

FIG. 17 illustrates a perspective view of an example camera module, in accordance with one or more embodiments.

FIG. 18 illustrates a schematic exploded perspective view of an example camera module, in accordance with one or more embodiments.

FIG. 19 is a perspective view illustrating an example in which a lens module and a carrier are separated from a housing in an example camera module, in accordance with one or more embodiments.

FIG. 20 illustrates a perspective view of the components illustrated in FIG. 19 viewed from another direction.

FIG. 21 illustrates a plan view of an example in which a case is removed from an example camera module, in accordance with one or more embodiments.

FIG. 22 illustrates a cross-sectional view taken along line II-II' of FIG. 17.

FIG. 23 illustrates an exploded perspective view illustrating a partial configuration of an example camera module, in accordance with one or more embodiments.

FIG. 24 illustrates a bottom perspective view of a lens holder and a guide frame included in an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Additionally, unless otherwise stated, a configuration included in an example embodiment disclosed in the specification may also be applied to other example embodiments.

In the specification, an optical axis (Z-axis) direction may refer to a direction in which an optical axis (Z-axis) of a lens module extends vertically or a direction parallel to the optical axis (Z-axis).

A first direction (X-direction) may refer to a direction perpendicular to an optical axis (Z-axis) direction, and a second direction (Y-direction) may refer to a direction perpendicular to both the optical axis (Z-axis) direction and the first direction (X-direction).

A camera module, in accordance with one or more embodiments, may be mounted in a portable electronic device. The portable electronic device may be, as examples, a portable electronic device such as, but not limited to, a mobile communication terminal, a smartphone, or a tablet personal computer (PC).

One or more examples may provide a camera module having a focus adjustment performance while being reduced in terms of size.

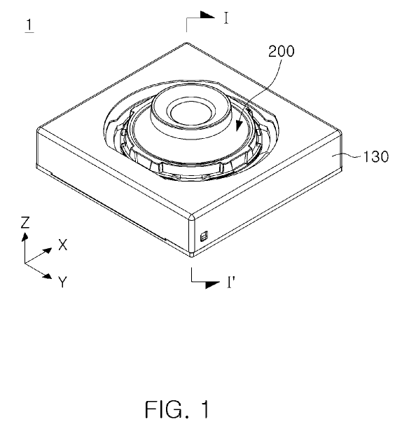

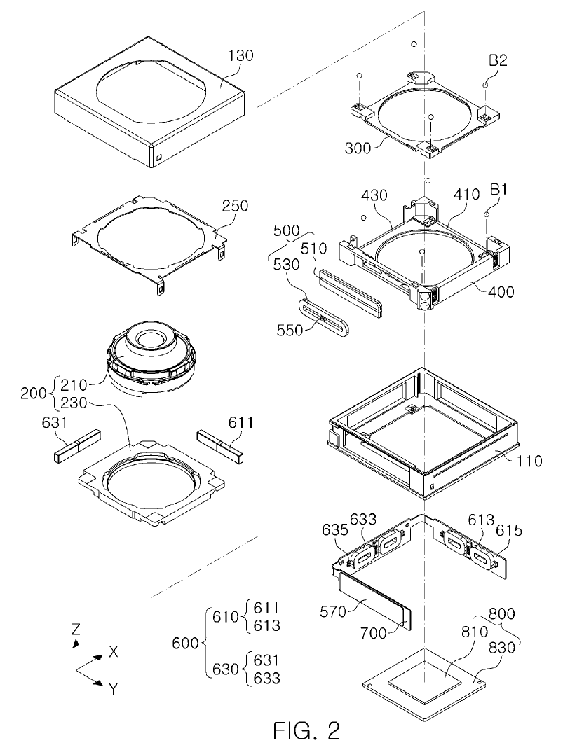

FIG. 1 illustrates a perspective view of the example camera module, in accordance with one or more embodiments, and FIG. 2 is a schematic exploded perspective view of the example camera module, in accordance with one or more embodiments.

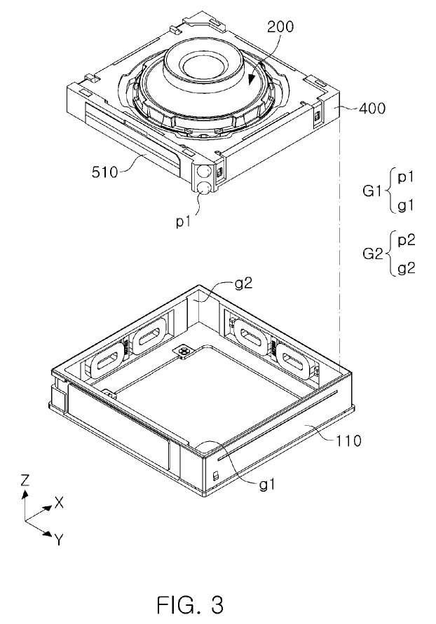

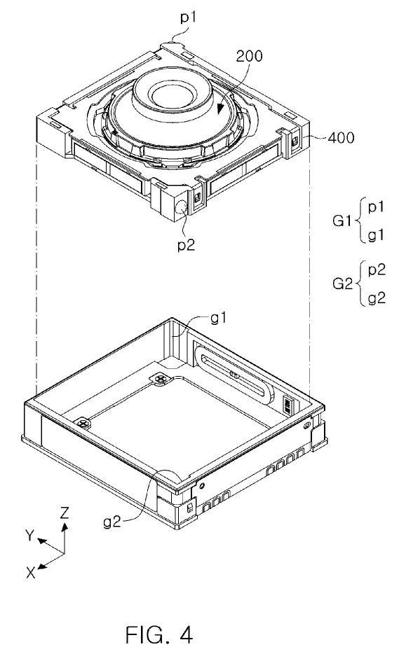

Additionally, FIG. 3 is a perspective view illustrating an example in which a lens module and a carrier are separated from a housing in the example camera module, in accordance with one or more embodiments, and FIG. 4 is a perspective view of the components illustrated in FIG. 3 viewed from another direction.

Referring to FIGS. 1-4, a camera module 1 according to an example embodiment may include a lens module 200, a carrier 400, a housing 110, and a first driving unit 500, and may further include a case 130.

The lens module 200 may include at least one lens and a lens barrel 210. At least one lens may be disposed inside the lens barrel 210. When a plurality of lenses are provided, the plurality of lenses may be mounted inside the lens barrel 210 along the optical axis (Z-axis).

The lens module 200 may further include a lens holder 230 coupled to the lens barrel 210.

In an example embodiment, the lens module 200 may be a moving member that moves in the optical axis (Z-axis) direction during automatic focus adjustment (AF). The lens module 200 may be moved in the optical axis (Z-axis) direction to perform the focus adjustment.

The carrier 400 may be disposed in the housing 110 and may move relative to the housing 110 in the optical axis (Z-axis) direction.

The lens module 200 may be disposed on the carrier 400, and the carrier 400 and the lens module 200 may be movable together in the optical axis (Z-axis) direction. Accordingly, a distance between the lens module 200 and an image sensor 810 may be changed to perform the focus adjustment.

The carrier 400 may be slidable, relative to the housing 110. For example, when the carrier 400 moves, sliding friction may occur between the carrier 400 and the housing 110.

The housing 110 has an inner space and may have a rectangular box shape having open upper and lower portions. The case 130 may be coupled to the housing 110 to protect an internal configuration of the camera module 1.

An image sensor module 800 may be disposed at a lower portion of the housing 110. The image sensor module 800 may be coupled to the housing 110.

The image sensor module 800 may include the image sensor 810 having an imaging surface and a printed circuit board 830 connected to the image sensor 810, and may further include an infrared filter.

The infrared filter may block light of an infrared region among light incident through the lens module 200.

The image sensor 810 may convert light incident through the lens module 200 into an electric signal. In a non-limited example, the image sensor 810 may be a charge coupled device (CCD) or a complementary metal-oxide semiconductor (CMOS).

The electric signal converted by the image sensor 810 may be output as an image through a display unit of the portable electronic device.

The image sensor 810 may be fixed to the printed circuit board 830 and may be electrically connected to the printed circuit board 830 by wire bonding.

The first driving unit 500 may generate a driving force in the optical axis (Z-axis) direction to move the carrier 400 in the optical axis (Z-axis) direction.

The first driving unit 500 may include a first magnet 510 and a first coil 530. The first magnet 510 and the first coil 530 may be disposed to face each other in a direction perpendicular to the optical axis (Z-axis).

The first magnet 510 may be disposed on the carrier 400. For example, the first magnet 510 may be disposed on one side surface of the carrier 400.

A back yoke may be disposed between the carrier 400 and the first magnet 510. The back yoke may improve the driving force by preventing magnetic flux leakage from the first magnet 510.

The first magnet 510 may be magnetized to have one surface (for example, a surface facing the first coil 530) having both a north pole (N-pole) and a south pole (S-pole). For example, the N-pole, a neutral region, and the S-pole may be disposed sequentially on one surface of the first magnet 510 facing the first coil 530 along the optical axis (Z-axis) direction.

The other surface (for example, a surface opposite to one surface) of the first magnet 510 may have a polarity opposite to a polarity of one surface of the first magnet 510.

The first coil 530 may be disposed to face the first magnet 510. For example, the first coil 530 may be disposed to face the first magnet 510 in the direction perpendicular to the optical axis (Z-axis).

The first coil 530 may be disposed on a substrate 700, and the substrate 700 may be mounted on the housing 110 to have the first magnet 510 and the first coil 530 facing each other in the direction perpendicular to the optical axis (Z-axis). Therefore, the first coil 530 may be fixed to the housing 110.

The first magnet 510 may be a moving member that is mounted on the carrier 400 to move together with the carrier 400 in the optical axis (Z-axis) direction, and the first coil 530 may be a fixed member that is fixed to the substrate 700.

When power is applied to the first coil 530, the carrier 400 may be moved in the optical axis (Z-axis) direction by an electromagnetic force acting between the first magnet 510 and the first coil 530.

The lens module 200 may be accommodated in the carrier 400, and the lens module 200 may thus also be moved in the optical axis (Z-axis) direction by the movement of the carrier 400.

A first guide portion G1 and a second guide portion G2 may be disposed between the carrier 400 and the housing 110. The first guide portion G1 and the second guide portion G2 may be spaced apart from each other in the direction perpendicular to the optical axis (Z-axis).

In an example embodiment, the first guide portion G1 and the second guide portion G2 may be spaced apart from each other in a diagonal direction of the carrier 400.

In the specification, the diagonal direction may indicate a direction that is inclined with respect to both the first direction (X-direction) and the second direction (Y-direction) in a plane perpendicular to the optical axis (Z-axis).

The first guide portion G1 may include a plurality of first protrusions p1 spaced apart from each other in the optical axis (Z-axis) direction, and the second guide portion G2 may include at least one second protrusion p2.

The plurality of first protrusions p1 may be disposed on the carrier or the housing.

At least one second protrusion p2 may be disposed on the carrier or the housing.

Hereinafter, an example embodiment in which the plurality of first protrusions p1 and at least one second protrusion p2 are disposed on the carrier is described.

However, in an example, the plurality of first protrusions p1 and at least one second protrusion p2 may be disposed on the housing. Additionally, one of the plurality of first protrusions p1 and at least one second protrusion p2 may be disposed on the carrier, and the other may be disposed on the housing.

A first yoke 570 may be disposed on the housing 110. The first yoke 570 may be disposed to face the first magnet 510. For example, the first coil 530 may be disposed on one surface of the substrate 700, and the first yoke 570 may be disposed on the other surface (for example, a surface opposite to one surface) of the substrate 700. Therefore, the first yoke 570 may be disposed to be fixed to the housing 110.

The first magnet 510 and the first yoke 570 may generate an attractive force between each other. For example, the attractive force may act between the first magnet 510 and the first yoke 570 in the direction perpendicular to the optical axis (Z-axis).

By the attractive force between the first magnet 510 and the first yoke 570, the plurality of first protrusions p1 and at least one second protrusion p2 may come into contact with the housing 110.

In an example, “contact” may indicate line contact or point contact.

The first guide portion G1 may further include a first guide groove g1 that comes into contact with the plurality of first protrusions p1, and the second guide portion G2 may further include a second guide groove g2 that comes into contact with at least one second protrusion p2.

When the plurality of first protrusions p1 are disposed on the carrier, the first guide groove g1 may be formed in the housing.

When at least one second protrusion p2 is disposed on the carrier, the second guide groove g2 may be formed in the housing.

The first guide groove g1 and the second guide groove g2 may extend along the direction parallel to the optical axis (Z-axis).

For example, the first guide groove g1 and the second guide groove g2 may extend to have lengths in the optical axis (Z-axis) direction.

The plurality of first protrusions p1 may protrude toward the first guide groove g1 from a side surface of the carrier. Additionally, the plurality of first protrusions p1 may be spaced apart from each other in the optical axis (Z-axis) direction.

Each of surfaces of the plurality of first protrusions p1 may include a curved surface.

In an example embodiment, the number of the plurality of first protrusions p1 may be two. One of the two first protrusions p1 may protrude from an upper end of one corner of the carrier, and the other one of the two first protrusions p1 may protrude from a lower end of one corner of the carrier.

Each of the plurality of first protrusions p1 may be in two-point contact with the first guide groove g1. The plurality of first protrusions p1 may be integrally formed with the carrier 400 and movable together with the carrier 400.

Sliding friction may occur on the plurality of first protrusions p1 as the carrier 400 moves.

The first guide portion G1 may operate as a main guide to guide the movement of the carrier 400 in the optical axis (Z-axis) direction.

At least one second protrusion p2 may protrude toward the second guide groove g2 from a side surface of the carrier. In an example embodiment, the number of at least one second protrusion p2 may be less than the number of the plurality of first protrusions p1.

When the number of the second protrusion p2 is one, one second protrusion p2 may protrude from a side surface of the carrier.

At least one second protrusion p2 may be in one-point contact with the second guide groove g2.

At least one second protrusion p2 may be integrally formed with the carrier 400 and movable together with the carrier 400.

Sliding friction may occur on at least one second protrusion p2 as the carrier 400 moves.

The second guide portion G2 may operate as an auxiliary guide to support the movement of the carrier 400 in the optical axis (Z-axis) direction.

The plurality of first protrusions p1 and at least one second protrusion p2 may all be moved together with the carrier. Accordingly, during a process in which the carrier is moved in the optical axis direction, a relative position between the support region formed by the plurality of first protrusions p1 and at least one second protrusion p2 and the carrier may not change, and may be maintained as it is.

Therefore, the carrier may be stably supported to move in a direction parallel to the optical axis direction.

Typically, when the movement of the carrier is supported by a plurality of ball members, it may be difficult to miniaturize the camera module because it is desirous to have a space in which the plurality of ball members perform rolling movement in the optical axis direction, and as the plurality of ball members perform the rolling movement in the optical axis direction, a relative position between a support region formed by the plurality of ball members and the carrier may change, which may result in the carrier not moving parallel to the optical axis (that is, tilt occurs).

That is, a moving distance of the carrier and a rolling distance of the plurality of ball members may be different from each other, the support region formed by the plurality of ball members may change during the movement of the carrier.

However, in the camera module according to an example embodiment, the plurality of first protrusions p1 and at least one second protrusion p2 supporting the carrier may be moved together with the carrier to prevent the support region of the carrier from changing during the movement of the carrier, thereby stably supporting the movement of the carrier.

That is, in the camera module according to an example embodiment, a moving distance of the carrier, a moving distance of the plurality of first protrusions p1, and a moving distance of at least one second protrusion p2 may not change during the movement of the carrier, thereby constantly maintaining the support region of the carrier at a constant level.

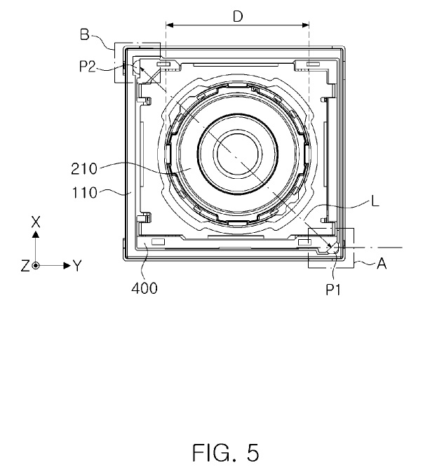

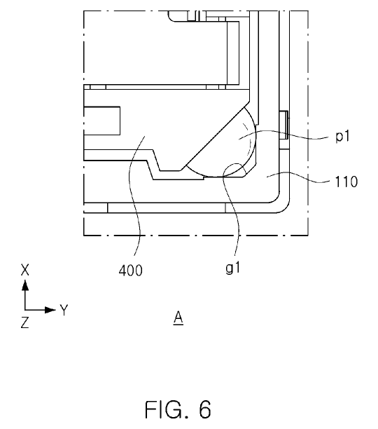

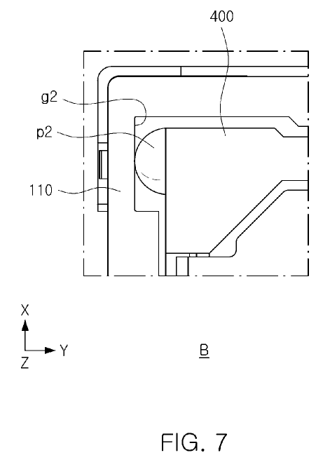

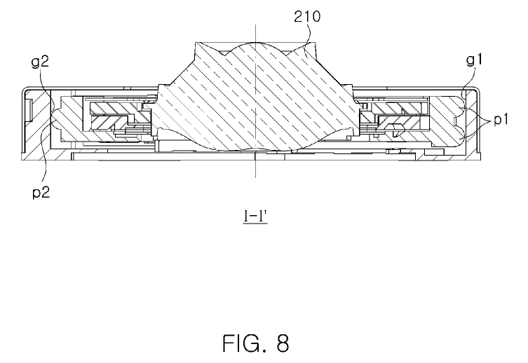

FIG. 5 is a plan view of an example in which the case is removed from the camera module according to an example embodiment, FIG. 6 is an enlarged view of portion A in FIG. 5, and FIG. 7 is an enlarged view of portion B in FIG. 5. In addition, FIG. 8 is a cross-sectional view taken along line I-I' of FIG. 1.

Referring to FIGS. 5-8, the first guide portion G1 and the second guide portion G2 may be spaced apart from each other in the direction perpendicular to the optical axis (Z-axis).

In an example, the first guide portion G1 and the second guide portion G2 may be spaced apart from each other in the diagonal direction of the carrier 400 (or the housing 110). Therefore, a distance between the first guide portion G1 and the second guide portion G2 may be greater than a length of one side surface of the carrier 400.

In an example, a distance between a vertex of the first protrusion p1 of the first guide portion G1 and a vertex of the second protrusion p2 of the second guide portion G2 may be greater than the length of one side surface of the carrier.

In an example, the distance between the vertex of the first protrusion p1 of the first guide portion G1 and the vertex of the second protrusion p2 of the second guide portion G2 may indicate a shortest distance between the vertex of the first protrusion p1 and the vertex of the second protrusion p2 when viewed in the optical axis (Z-axis) direction.

Additionally, the length of one side surface of the carrier 400 may indicate a distance between both ends of one side surface of the carrier 400 in the second direction (Y-direction) when the carrier 400 is viewed from the first direction (X-direction). Alternatively, the length of one side surface of the carrier 400 may indicate a distance between both ends of one side surface of the carrier 400 in the first direction (X-direction) when the carrier 400 is viewed from the second direction (Y-direction).

The first guide portion G1 may be disposed close to the first magnet 510, and the second guide portion G2 may be disposed farther from the first magnet 510 (that is, farther than the first guide portion G1). An imaginary line extending along a length direction of the first magnet 510 from one surface of the first magnet 510 in contact with the carrier 400 may pass through the first protrusion p1 and be spaced apart from the second protrusion p2.

Typically, when a plurality of balls are disposed on both sides of the first magnet in the length direction, all of the balls may be pressed in the same direction (for example, a direction in which the first magnet and the first yoke face each other) by attractive force between the first magnet and the first yoke. Additionally, in the example in which the carrier is supported in this manner, the carrier may be moved in the optical axis (Z-axis) direction.

However, the center of the carrier (for example, the center of gravity) may be spaced apart from a surface of the carrier supported by the plurality of balls. Accordingly, when the carrier is moved in the optical axis (Z-axis) direction, the carrier may not be moved to be parallel to the optical axis (Z-axis), and tilt may occur.

In the camera module 1 according to an example embodiment, the first guide portion G1 may be disposed on one of both sides of the first magnet 510 in the length direction and the second guide portion G2 may be disposed to be spaced apart from the first guide portion G1 in the diagonal direction of the carrier 400, thereby causing a rotational force around the first guide portion G1 (for example, the vertex of the first protrusion p1) by the attractive force between the first magnet 510 and the first yoke 570.

Accordingly, the carrier 400 may tend to rotate around the first protrusion p1 as a rotation axis, and based on this rotational force, the second protrusion p2 may maintain a contact state with the housing 110.

That is, the rotational force may be generated in the carrier 400 by disposing the first guide portion G1 and the second guide portion G2 to be spaced apart from each other in the diagonal direction of the carrier 400, and based on this rotational force, the first protrusion p1 and the second protrusion p2 may come into contact with the housing 110.

Although the rotational force is applied to the carrier 400, each of the first protrusion p1 and the second protrusion p2 may come into contact with the housing, thereby preventing rotation of the carrier 400, and the carrier 400 may be supported to move in the optical axis (Z-axis) direction.

The camera module 1 according to an example embodiment may allow the center of the carrier 400 to be positioned within a region connecting a portion supported by the first protrusion p1 and a portion supported by the second protrusion p2 (that is, the region where the carrier 400 is supported and the center of the carrier 400 are not spaced apart from each other), and the carrier 400 may thus move in a direction that is parallel to the optical axis (Z-axis). Therefore, driving stability may be improved during the focus adjustment.

In an example, the center of one side surface of the carrier 400 on which the first magnet 510 is mounted and the center of the first magnet 510 may not match each other.

In an example, when viewed in the first direction (X-direction), the center of the first magnet 510 may be disposed closer to the first guide portion G1 than to the center of one side surface of the carrier 400. In this example, an attractive force between the first magnet 510 and the first yoke 570 may be generated at a position close to the first guide portion G1, which is the main guide, thereby further improving the driving stability during the focus adjustment.

When viewed in the optical axis (Z-axis) direction, the center of the carrier 400 (or the center of the lens module 200) may be positioned within a region connecting both ends of the first protrusion p1 to both ends of the second protrusion p2.

When viewed in the optical axis (Z-axis) direction, a center 810a of the image sensor 810 (for example, the center of an effective imaging surface of the image sensor 810) may be positioned within the region connecting both the ends of the first protrusion p1 and both the ends of the second protrusion p2.

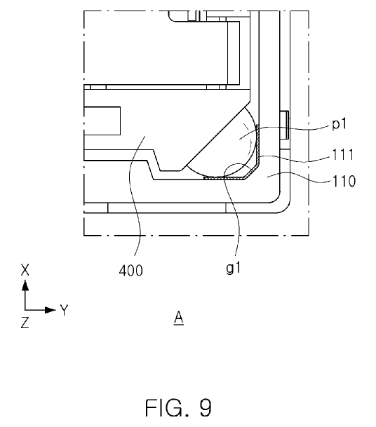

FIG. 9 is a view illustrating a first modified example of the first guide portion included in the camera module, according to an example embodiment.

Referring to FIG. 9, the first guide portion G1 may further include a guide plate 111.

The guide plate 111 may be disposed in the first guide groove g1. In an example embodiment, when the plurality of first protrusions p1 are formed on the carrier 400, the first guide groove g1 may be formed in the housing 110, and the guide plate 111 may also be formed on the housing 110.

The guide plate 111 may be made of a material that is different from a material of the housing 110. In a non-limited example embodiment, the guide plate 111 may be made of a metal material.

The guide plate 111 may be insert-injected into the housing 110 and provided. Therefore, the guide plate 111 may be integrally formed with the housing 110, and one surface of the guide plate 111 may be exposed outward from the housing 110.

An exposed portion of the guide plate 111 may form an inner wall of the first guide groove g1, and the plurality of first protrusions p1 may come into contact with the guide plate 111.

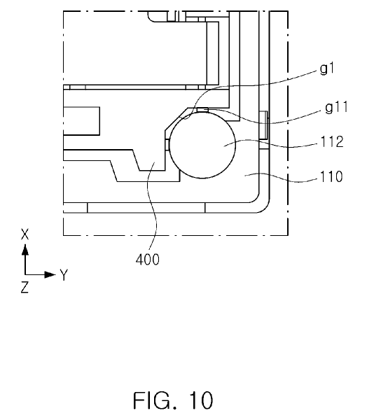

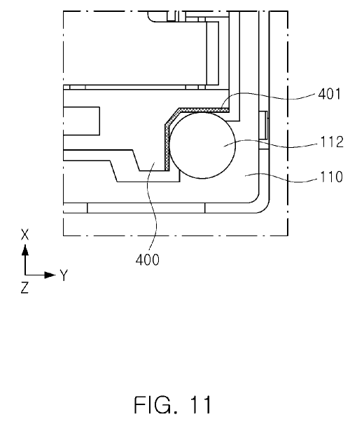

FIGS. 10 and 11 are views illustrating a second modified example of the first guide portion included in the camera module according to an example embodiment.

Referring to FIG. 10, the first guide portion G1 may further include a shaft 112. The shaft 112 may have a cylindrical shape having a length in the optical axis (Z-axis) direction.

The shaft 112 may be insert-injected into the carrier 400 or the housing 110 and provided. Therefore, the shaft 112 may be integrally formed with the carrier 400 or the housing 110. FIG. 10 illustrates an example in which the shaft 112 is integrally coupled to the housing 110. In this example, the first guide groove gb may be formed in the carrier 400 facing the shaft 112.

At least a portion of a side surface of the shaft 112 may be disposed to be exposed outward from an inserted member (for example, the housing 110).

The shaft 112 may be made of a material that is different from a material of the housing 110. In a non-limited example embodiment, the shaft 112 may be made of a metal material.

When the shaft 112 is disposed on the housing 110, a plurality of protrusions g11 may be formed on the carrier 400. The shaft 112 may be in contact with the plurality of protrusions g11 of the carrier 400. In an example embodiment, the plurality of protrusions g11 may protrude from the first guide groove g1.

In an example embodiment, the plurality of protrusions g11 may be provided in a total of four, two of the plurality of protrusions g11 may be provided at an upper side in the optical axis (Z-axis) direction and two of the plurality of protrusions g11 may be provided at a lower side in the optical axis (Z-axis) direction. Therefore, the shaft 112 may be in two-point contact with the two protrusions g11 provided at the upper side in the optical axis (Z-axis) direction and may be in two-point contact with the two protrusions g11 provided at the lower side in the optical axis (Z-axis) direction.

Referring to FIG. 11, a guide plate 401 may be disposed on the carrier 400, and the shaft 112 may be in contact with the guide plate 401.

The guide plate 401 may be insert-injected into the carrier 400 to function as an inner wall of the first guide groove g1. In this example, the shaft 112 may be in line contact with the guide plate 401.

In another example, the plurality of protrusions g11 illustrated in FIG. 10 may be formed on the guide plate 401. That is, the guide plate 401 may include a plurality of protrusions that protrude toward the shaft 112.

In another example, the guide plate 401 may be disposed on a surface of each of the plurality of protrusions g11 illustrated in FIG. 10.

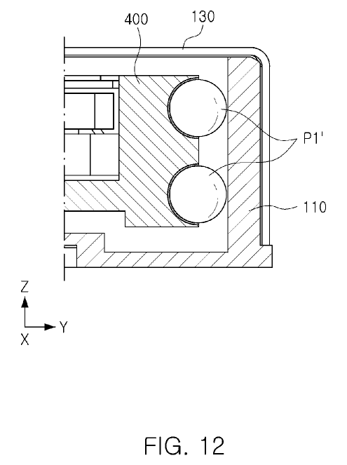

FIGS. 12-14 are views illustrating a third modified example of the first guide portion included in the camera module according to an example embodiment.

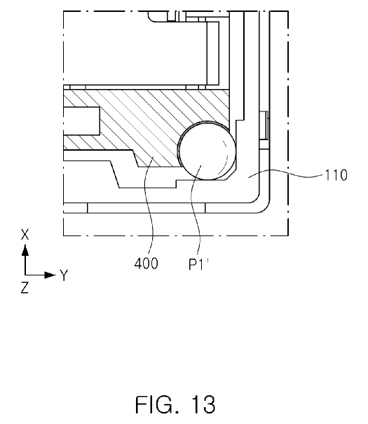

Referring to FIGS. 12 and 13, a plurality of first protrusions p1′ may be provided as a plurality of balls.

In an example, the plurality of balls may be coupled to the carrier 400 to operate as the plurality of first protrusions p1′.

The plurality of balls may be fixed to the carrier 400 and movable together with the carrier 400.

In an example embodiment, the plurality of balls may be bonded to the carrier 400 by using an adhesive, as only an example.

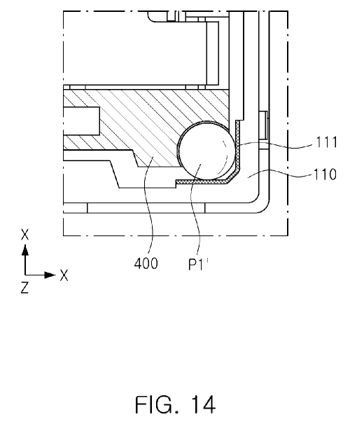

Referring to FIG. 14, the guide plate 111 may be disposed on the housing 110, and the plurality of balls may come into contact with the guide plate 111.

In an example, the camera module 1 may detect a position of the carrier 400 in the optical axis (Z-axis) direction.

Accordingly, referring again to FIG. 2, a first position sensor 550 may be provided. The first position sensor 550 may be disposed on the substrate 700 to face the first magnet 510. In an example, the first position sensor 550 may be a Hall sensor.

In an example, the camera module 1 may perform optical image stabilization during the capturing an image by moving the lens module 200 in the direction perpendicular to the optical axis (Z-axis). Accordingly, the camera module 1 may include a second driving unit 600 that moves the lens module 200 in the direction perpendicular to the optical axis (Z-axis).

Referring to FIG. 2, a guide frame 300 and the lens module 200 may be sequentially accommodated in the carrier 400. For example, the guide frame 300 may be disposed between the carrier 400 and the lens module 200. The guide frame 300 may have a rectangular plate shape having a hollow.

Based on a driving force of the second driving unit 600, the guide frame 300 and the lens module 200 may be moved together in the first direction (X-direction), and the lens module 200 may be moved relative to the guide frame 300 in the second direction (Y-direction).

The second driving unit 600 may include a first sub-driving unit 610 and a second sub-driving unit 630. The first sub-driving unit 610 may generate a driving force in the first direction (X-direction), and the second sub-driving unit 630 may generate a driving force in the second direction (Y-direction).

The first sub-driving unit 610 may include a second magnet 611 and a second coil 613. The second magnet 611 and the second coil 613 may be disposed to face each other in the first direction (X-direction).

The second magnet 611 may be disposed on the lens module 200. For example, the second magnet 611 may be mounted on one side surface of the lens holder 230.

The second coil 613 may be disposed to face the second magnet 611. For example, the second coil 613 may be disposed to face the second magnet 611 in the first direction (X-direction).

The second coil 613 may have a doughnut shape with a hollow portion. The second coil 613 may include a plurality of coils. For example, the second coil 613 may include two coils that are spaced apart from each other in the second direction (Y-direction), and each coil may be disposed to face the second magnet 611.

Additionally, polarities of respective surfaces of the second magnet 611 facing the two coils may be different from each other. For example, one of the two coils may face an N-pole of the second magnet 611, and the other may face an S-pole of the second magnet 611.

During optical image stabilization, the second magnet 611 may be a moving member that is mounted on the lens holder 230, and the second coil 613 may be a fixed member fixed to the housing 110.

When power is applied to the second coil 613, the lens module 200 and the guide frame 300 may be moved in the first direction (X-direction) by an electromagnetic force between the second magnet 611 and the second coil 613.

The second magnet 611 and the second coil 613 may generate a driving force in directions in which the second magnet 611 and the second coil 613 face each other (for example, the first direction (X-direction)).

The second sub-driving unit 630 may include a third magnet 631 and a third coil 633. The third magnet 631 and the third coil 633 may be disposed to face each other in the second direction (Y-direction).

The third magnet 631 may be disposed on the lens module 200. For example, the third magnet 631 may be mounted on the other side surface of the lens holder 230.

The third coil 633 may be disposed to face the third magnet 631. For example, the third coil 633 may be disposed to face the third magnet 631 in the second direction (Y-direction).

The third coil 633 may have a doughnut shape with a hollow portion. The third coil 633 may include a plurality of coils. In an example, the third coil 633 may include two coils that are spaced apart from each other in the first direction (X-direction), and each coil may be disposed to face the third magnet 631.

Additionally, polarities of respective surfaces of the third magnet 631 facing the two coils may be different from each other. For example, one of the two coils may face an N-pole of the third magnet 631, and the other may face an S-pole of the third magnet 631.

The second coil 613 and the third coil 633 may be disposed on the substrate 700. In an example, the second coil 613 and the third coil 633 may be disposed on the substrate 700 to face the second magnet 611 and the third magnet 631, respectively.

The substrate 700 may be mounted on a side surface of the housing 110, and through an opening disposed in the housing 110, the second coil 613 and the third coil 633 may directly face the second magnet 611 and the third magnet 631.

The substrate 700 may be mounted on the housing 110 to cover three side surfaces of the housing 110. In an example embodiment, when viewed in the optical axis (Z-axis) direction, the substrate 700 may have a substantially 'C'-shaped form.

The first guide portion G1 may be disposed at one corner of the housing 110, and the second guide portion G2 may be disposed at another corner of the housing 110. The substrate 700 may be disposed to surround another corner of the housing 110.

During optical image stabilization, the third magnet 631 may be a moving member that is mounted on the lens holder 230, and the third coil 633 may be a fixed member that is fixed to the housing 110.

When power is applied to the third coil 633, the lens module 200 may be moved in the second direction (Y-direction) by an electromagnetic force between the third magnet 631 and the third coil 633.

The third magnet 631 and the third coil 633 may generate a driving force in a direction in which the third magnet 631 and the third coil 633 face each other (for example, the second direction (Y-direction)).

The second magnet 611 and the third magnet 631 may be disposed to be perpendicular to each other in a plane perpendicular to the optical axis (Z-axis), and the second coil 613 and the third coil 633 may also be disposed to be perpendicular to each other in the plane perpendicular to the optical axis (Z-axis).

In an example, each of the second magnet 611 and the third magnet 631 may be disposed closer to the second guide portion G2 than to the first guide portion G1.

The camera module 1, according to an example embodiment, may include a plurality of ball members that support the guide frame 300 and the lens module 200. The plurality of ball members may guide the movement of the guide frame 300 and the lens module 200 during an optical image stabilization process. Additionally, the plurality of ball members may also maintain a distance between the carrier 400, the guide frame 300, and the lens module 200.

The plurality of ball members may include a first ball member B1 and a second ball member B2.

The first ball member B1 may guide the movement of the guide frame 300 and the lens module 200 in the first direction (X-direction), and the second ball member B2 may guide the movement of the lens module 200 in the second direction (Y-direction).

In an example, when a driving force is generated in the first direction (X-direction), the first ball member B1 may perform a rolling motion in the first direction (X-direction). Accordingly, the first ball member B1 may guide the movement of the guide frame 300 and the lens module 200 in the first direction (X-direction).

When a driving force is generated in the second direction (Y-direction), the second ball member B2 may perform a rolling motion in the second direction (Y-direction). Accordingly, the second ball member B2 may guide the movement of the lens module 200 in the second direction (Y-direction).

The first ball member B1 may include a plurality of balls disposed between the carrier 400 and the guide frame 300, and the second ball member B2 may include a plurality of balls disposed between the guide frame 300 and the lens module 200.

In an example, referring to FIG. 2, each of the first ball member B1 and the second ball member B2 may include four balls.

A first guide groove portion G3 that accommodates the first ball member B1 may be formed in at least one of surfaces of the carrier 400 and the guide frame 300 that face each other in the optical axis (Z-axis) direction. The first guide groove portion G3 may include a plurality of guide grooves corresponding to the plurality of balls of the first ball member B1.

The first ball member B1 may be accommodated in the first guide groove portion G3 and interposed between the carrier 400 and the guide frame 300.

In an example in which the first ball member B1 is accommodated in the first guide groove portion G3, a movement of the first ball member B1 in the optical axis (Z-axis) direction and the second direction (Y-direction) may be restricted, and a movement of the first ball member B1 only in the first direction (X-direction) may be allowed. In an example, the first ball member B1 may perform a rolling motion only in the first direction (X-direction).

Accordingly, a planar shape of each of the plurality of guide grooves of the first guide groove portion G3 may be a rectangle having a length in the first direction (X-direction).

A second guide groove portion G4 that accommodates the second ball member B2 may be formed in at least one of surfaces of the guide frame 300 and the lens module 200 (for example, the lens holder 230) facing each other in the optical axis (Z-axis) direction. The second guide groove portion G4 may include a plurality of guide grooves that correspond to the plurality of balls of the second ball member B2.

The second ball member B2 may be accommodated in the second guide groove portion G4, and may be interposed between the guide frame 300 and the lens module 200.

In an example in which the second ball member B2 is accommodated in the second guide groove portion G4, a movement of the second ball member B2 in the optical axis (Z-axis) direction and the first direction (X-direction) may be restricted, and a movement of the second ball member B2 may be allowed in only in the second direction (Y-direction). For example, the second ball member B2 may perform a rolling motion only in the second direction (Y-direction).

Accordingly, a planar shape of each of the plurality of guide grooves of the second guide groove portion G4 may be a rectangle having a length in the second direction (Y-direction).

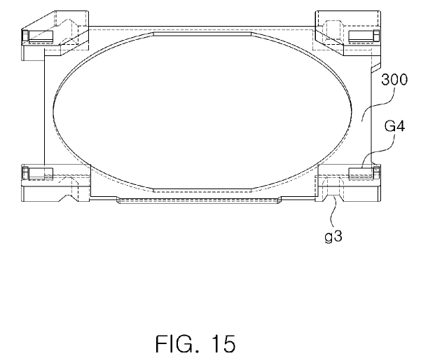

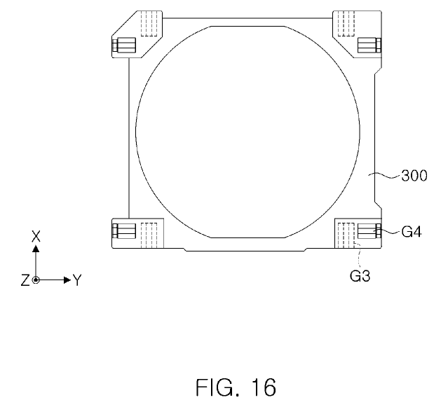

FIG. 15 is a perspective view of the guide frame included in the camera module according to an example embodiment, and FIG. 16 is a plan view of the guide frame illustrated in FIG. 15.

In an example embodiment, the first guide groove portion G3 in which the first ball member B1 is disposed may be formed in a lower surface of the guide frame 300 that faces the carrier 400 in the optical axis (Z-axis) direction. Additionally, the second guide groove portion G4 in which the second ball member B2 is disposed may be formed in an upper surface of the guide frame 300 that faces the lens module 200 in the optical axis (Z-axis) direction.

The first guide groove portion G3 and the second guide groove portion G4 may be disposed not to overlap with each other when viewed in the optical axis (Z-axis) direction.

The first ball member B1 and the second ball member B2 may be accommodated in the first guide groove portion G3 and the second guide groove portion G4, respectively, and each of the first guide groove portion G3 and the second guide groove portion G4 may have a predetermined depth. Therefore, when the first guide groove portion G3 and the second guide groove portion G4 are disposed to overlap each other in the optical axis (Z-axis) direction, the guide frame 300 may be formed to be thick in the optical axis (Z-axis) direction, thereby causing an increased height of the camera module 1 in the optical axis (Z-axis) direction.

However, the camera module 1 according to an example embodiment may form the guide frame 300 to be relatively thin by disposing the first guide groove portion G3 and the second guide groove portion G4 not to overlap each other in the optical axis (Z-axis) direction, thereby reducing a height of the camera module 1 in the optical axis (Z-axis) direction.

In an example embodiment, the first guide groove portion G3 and the second guide groove portion G4 may be disposed not to overlap with each other in the first direction (X-direction). Additionally, the first guide groove portion G3 and the second guide groove portion G4 may be disposed to have some guide grooves overlapping with each other in the second direction (Y-direction) and the remaining guide grooves not overlapping with each other in the second direction (Y-direction).

When a driving force is generated in the first direction (X-direction), the guide frame 300 and the lens module 200 may move together in the first direction (X-direction).

In an example, the first ball member B1 may perform a rolling motion along the first direction (X-direction). In an example, the movement of the second ball member B2 may be restricted.

Additionally, when a driving force is generated in the second direction (Y-direction), the lens module 200 may be moved relative to the guide frame 300 in the second direction (Y-direction).

IN an example, the second ball member B2 may perform a rolling motion along the second direction (Y-direction). In an example, the movement of the first ball member B1 may be restricted.

In an example embodiment, the camera module 1 may detect a position of the lens module 200 in the direction perpendicular to the optical axis (Z-axis).

Accordingly, in an example, and referring to FIG. 2, a second position sensor 615 and a third position sensor 635 may be provided. The second position sensor 615 may be disposed on the substrate 700 to face the second magnet 611, and the third position sensor 635 may be disposed on the substrate 700 to face the third magnet 631. In an example, the second position sensor 615 and the third position sensor 635 may be Hall sensors.

At least one of the second position sensor 615 and the third position sensor 635 may include two Hall sensors. For example, the second position sensor 615 may include two Hall sensors disposed to face the second magnet 611.

Whether the lens module 200 is rotated may be detected through the two Hall sensors facing the second magnet 611. The second coil 613 may include two coils facing the second magnet 611, and the second coil 613 may thus be controlled to offset a rotational force applied to the lens module 200.

Although the configuration of the first guide groove portion G3 and the second guide groove portion G4 in which the first ball member B1 and the second ball member B2 are disposed may prevent the rotation of the lens module 200, the lens module 200 may be slightly rotated due to an influence of tolerances occurring during a manufacturing process of mechanical components.

However, the camera module 1 according to an example embodiment may detect whether the lens module 200 is rotated and may offset a corresponding rotational force by the second coil 613 and the second position sensor 615.

One or more examples may provide a second yoke 410 and a third yoke 430 which allow the carrier 400 and the guide frame 300 to be maintained in a contact state with the first ball member B1 and to allow the guide frame 300 and the lens module 200 to maintain a contact state with the second ball member B2.

The second yoke 410 and the third yoke 430 may be fixed to the carrier 400 and disposed to face the second magnet 611 and the third magnet 631 in the optical axis (Z-axis) direction.

Therefore, attractive forces may be generated in the optical axis (Z-axis) direction between the second yoke 410 and the second magnet 611, and between the third yoke 430 and the third magnet 631, respectively.

The lens module 200 and the guide frame 300 may be pressed toward the second yoke 410 and the third yoke 430 based on the attractive forces between the second yoke 410 and the second magnet 611 and between the third yoke 430 and the third magnet 631, and the guide frame 300 and the lens module 200, may thus maintain contact states with the first ball member B1 and the second ball member B2.

Each of the second yoke 410 and the third yoke 430 may be made of a material that generates an attractive force between the second magnet 611 and the third magnet 631. In an example, each of the second yoke 410 and the third yoke 430 may be made of a magnetic material.

In an example, a stopper 250 may be coupled to the carrier 400 to cover at least a portion of an upper surface of the lens module 200. For example, the stopper 250 may cover at least a portion of an upper surface of the lens holder 230.

The stopper 250 may prevent the guide frame 300 and the lens module 200 from being separated outward from the carrier 400 due to an external impact or the like.

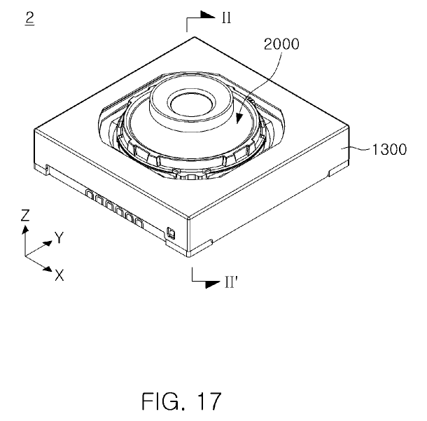

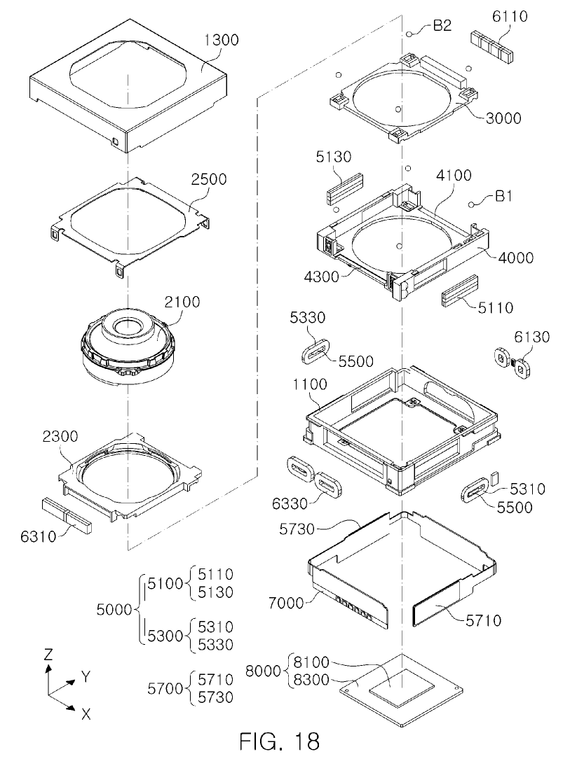

FIG. 17 is a perspective view of a camera module according to another example embodiment, and FIG. 18 is a schematic exploded perspective view of the camera module according to another example embodiment.

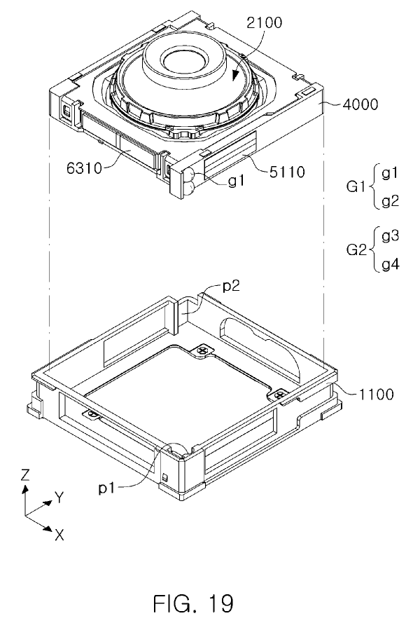

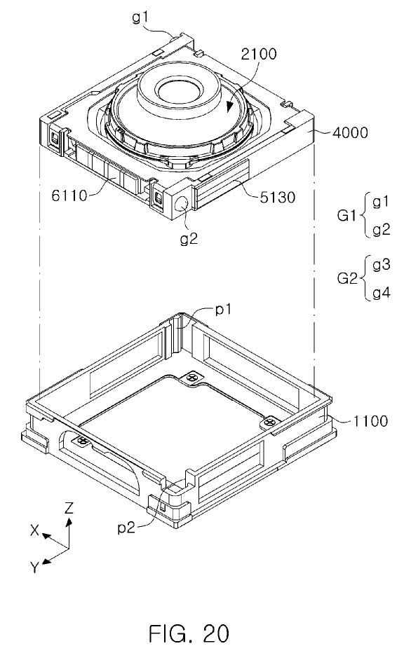

Additionally, FIG. 19 is a perspective view illustrating an example in which a lens module and a carrier are separated from a housing in the camera module according to another example embodiment, and FIG. 20 is a perspective view of the components illustrated in FIG. 19 viewed from another direction.

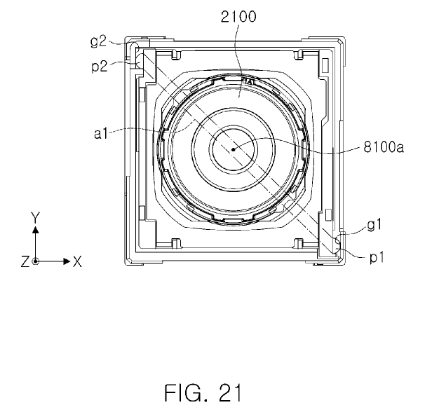

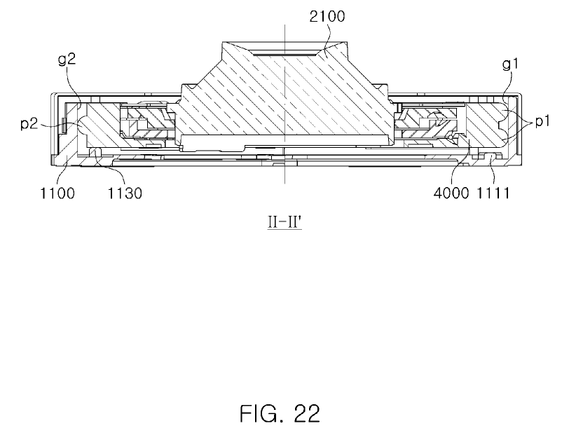

Additionally, FIG. 21 is a plan view of an example in which a case is removed from the camera module according to another example embodiment, and FIG. 22 is a cross-sectional view taken along line II-II' of FIG. 17.

Referring to FIGS. 17 and 18, a camera module 2, according to another example embodiment, may include a lens module 2000, a carrier 4000, a housing 1100, and a first driving unit 5000, and may further include a case 1300.

The lens module 2000 may include at least one lens and a lens barrel 2100. The at least one lens may be disposed inside the lens barrel 2100. When a plurality of lenses are provided, the plurality of lenses may be mounted inside the lens barrel 2100 along the optical axis (Z-axis).

The lens module 2000 may further include a lens holder 2300 that is coupled to the lens barrel 2100.

The lens module 2000 may be a moving member that is moved in the optical axis (Z-axis) direction during automatic focus adjustment (AF). The lens module 2000 may be moved in the optical axis (Z-axis) direction to perform the focus adjustment.

The carrier 4000 may be disposed in the housing 1100, and may be movable relative to the housing 1100 in the optical axis (Z-axis) direction.

The lens module 2000 may be disposed on the carrier 4000, and the carrier 4000 and the lens module 2000 may be movable together in the optical axis (Z-axis) direction. Accordingly, a distance between the lens module 2000 and an image sensor may be changed to perform the focus adjustment.

The housing 1100 has an inner space and may have a rectangular box shape having open upper and lower portions. The case 1300 may be coupled to the housing 1100 to protect an internal configuration of the camera module 2.

An image sensor module 8000 may be disposed at a lower portion of the housing 1100. The image sensor module 8000 may be coupled to the housing 1100.

The image sensor module 8000 may include an image sensor 8100 having an imaging surface and a printed circuit board 8300 connected to the image sensor 8100, and may further include an infrared filter.

The infrared filter may block light in an infrared region among light incident through the lens module 2000.

The image sensor 8100 may convert light incident through the lens module 2000 into an electrical signal. In a non-limited example, the image sensor 8100 may be a charge coupled device (CCD) or a complementary metal-oxide semiconductor (CMOS).

An electrical signal converted by the image sensor 8100 may be output as an image through a display unit of a portable electronic device.

The image sensor 8100 may be fixed to the printed circuit board 8300 and may be electrically connected to the printed circuit board 8300 by wire bonding.

The first driving unit 5000 may generate a driving force in the optical axis (Z-axis) direction to move the carrier 4000 in the optical axis (Z-axis) direction.

The first driving unit 5000 may include a first magnet 5100 and a first coil 5300. The first magnet 5100 and the first coil 5300 may be disposed to face each other in a direction perpendicular to the optical axis (Z-axis).

The first magnet 5100 may be coupled to the carrier 4000. A back yoke may be disposed between the carrier 4000 and the first magnet 5100. The back yoke may improve the driving force by preventing magnetic flux leakage from the first magnet 5100.

The first magnet 5100 may be magnetized to have one surface (for example, a surface facing the first coil 5300) having both a north pole (N-pole) and a south pole (S-pole). In an example, the N-pole, a neutral region, and the S-pole may be disposed sequentially on one surface of the first magnet 5100 facing the first coil 5300 along the optical axis (Z-axis) direction.

The other surface (for example, a surface opposite to the one surface) of the first magnet 5100 may be magnetized to have both the S and N-poles. For example, the N-pole, a neutral region, and the S-pole may be disposed sequentially on the other surface of the first magnet 5100 along the optical axis (Z-axis) direction.

The first magnet 5100 may include a first sub-magnet 5110 and a second sub-magnet 5130. The first sub-magnet 5110 may be disposed on one side surface of the carrier 4000, and the second sub-magnet 5130 may be disposed on the other side surface of the carrier 4000.

A first side surface and a second side surface of the carrier 4000 may be spaced apart from each other in the direction perpendicular to the optical axis (Z-axis) (for example, the first direction (X-direction)).

The first coil 5300 may be disposed to face the first magnet 5100. For example, the first coil 5300 may be disposed to face the first magnet 5100 in the direction perpendicular to the optical axis (Z-axis).

The first coil 5300 may be disposed on a substrate 7000, and the substrate 7000 may be mounted on the housing 1100 to allow the first magnet 5100 and the first coil 5300 to face each other in the direction perpendicular to the optical axis (Z-axis). Accordingly, the first coil 5300 may be fixed to the housing 1100.

The first coil 5300 may include a first sub-coil 5310 facing the first sub-magnet 5110, and a second sub-coil 5330 facing the second sub-magnet 5130.

The first magnet 5100 may be a moving member mounted on the carrier 4000 and movable together with the carrier 4000 in the optical axis (Z-axis) direction, and the first coil 5300 may be a fixed member fixed to the substrate 7000.

When power is applied to the first coil 5300, the carrier 4000 may be moved in the optical axis (Z-axis) direction based on an electromagnetic force between the first magnet 5100 and the first coil 5300.

The lens module 2000 may be accommodated in the carrier 4000, and the lens module 2000 may thus also be moved in the optical axis (Z-axis) direction by the movement of the carrier 4000.

A first guide portion G1 and a second guide portion G2 may be disposed between the carrier 4000 and the housing 1100. The first guide portion G1 may include a plurality of first protrusions p1 and a first guide groove g1 spaced apart from each other in the optical axis direction, and the second guide portion G2 may include at least one second protrusion p2 and a second guide groove g2.

The plurality of first protrusions p1 may be pressed toward the housing in a positive first direction, and at least one second protrusion p2 may also be pressed toward the housing in a negative first direction.

The plurality of first protrusions p1 may protrude from one side surface of the carrier 4000, and may be in two-point contact with the first guide groove g1, respectively. The first guide groove g1 may be formed in one inner surface of the housing.

At least one second protrusion p2 may protrude from the other side surface of the carrier 4000 and may be in one-point contact with the second guide groove g2. The second guide groove g2 may be formed in the other inner surface of the housing.

In another example embodiment, the plurality of first protrusions p1 and at least one second protrusion p2 may be formed on the housing, and the first guide groove g1 and the second guide groove g2 may be formed in the carrier.

Alternatively, one of the plurality of first protrusions p1 and at least one second protrusion p2 may be formed on the carrier, and the other may be formed on the housing.

The configurations of the first guide portion G1 and the second guide portion G2 are similar to those of the camera module 1 according to the example embodiment described above, and detailed descriptions thereof are thus omitted.

A first yoke 5700 may be disposed in the housing 1100. The first yoke 5700 may be disposed to face the first magnet 5100. For example, the first coil 5300 may be disposed on a first surface of the substrate 7000, and the first yoke 5700 may be disposed on a second surface (for example, a surface opposite to the first surface) of the substrate 7000. Accordingly, the first yoke 5700 may be disposed to be fixed to the housing 1100.

An attractive force may be generated between the first magnet 5100 and the first yoke 5700. For example, the attractive force may act between the first magnet 5100 and the first yoke 5700 in the direction perpendicular to the optical axis (Z-axis).

Based on the attractive force between the first magnet 5100 and the first yoke 5700, the plurality of first protrusions p1 of the first guide portion G1 and at least one second protrusion p2 of the second guide portion G2 may come into contact with the housing 1100, respectively.

The first yoke 5700 may include a first sub-yoke 5710 which faces the first sub-magnet 5110, and a second sub-yoke 5730 which faces the second sub-magnet 5130.

An attractive force may act between the first sub-magnet 5110 and the first sub-yoke 5710, and an attractive force may act between the second sub-magnet 5130 and the second sub- yoke 5730.

The first sub-magnet 5110 may be eccentrically disposed on a first side surface of the carrier 4000 toward the first guide portion G1. In an example, the first sub-magnet 5110 may be eccentrically disposed on a first side surface of the carrier 4000 toward the first guide portion G1 along a length direction of the first sub-magnet 5110 (i.e., the second direction (Y-direction)). That is, the center of the first sub-magnet 5110 may be positioned closer to the first guide portion G1 than to the center of a first side surface of the carrier 4000.

The second sub-magnet 5130 may be eccentrically disposed on a second side surface of the carrier 4000 toward the second guide portion G2. For example, the second sub-magnet 5130 may be eccentrically disposed on the second side surface of the carrier 4000 toward the second guide portion G2 along a length direction of the second sub-magnet 5130 (i.e., the second direction (Y-direction)). That is, the center of the second sub-magnet 5130 may be positioned closer to the second guide portion G2 than to the center of the second side surface of the carrier 4000.

In an example embodiment, the centers of the first sub-magnet 5110 and the second sub-magnet 5130 may be spaced apart from each other in the second direction (Y-direction).

An imaginary line that extends from one surface of the first sub-magnet 5110 in contact with the carrier 4000 along the length direction of the first sub-magnet 5110 may pass through the first guide portion G1, and may be spaced apart from the second guide portion G2. Additionally, an imaginary line that extends from one surface of the second sub-magnet 5130 in contact with the carrier 4000 along a length direction of the second sub-magnet 5130 may pass through the second guide portion G2, and may be spaced apart from the first guide portion G1.

An attractive force may act between the first sub-magnet 5110 and the first sub-yoke 5710, and an attractive force may act between the second sub-magnet 5130 and the second sub-yoke 5730.

In an example, the first sub-magnet 5110 may be eccentrically disposed on a first side surface of the carrier 4000 toward the first guide portion G1, and the second sub-magnet 5130 may be eccentrically disposed on a second side surface of the carrier 4000 toward the second guide portion G2, and a rotational force may thus act on the carrier 4000 based on attractive forces acting between the first sub-magnet 5110 and the first sub-yoke 5710, and between the second sub-magnet 5130 and the second sub-yoke 5730.

Based on this rotational force, the plurality of first protrusions p1 of the first guide portion G1 and at least one second protrusion p2 of the second guide portion G2 may maintain contact with the housing 1100.

That is, the rotational force may be generated in the carrier 4000 by an arrangement in which the first guide portion G1 and the second guide portion G2 are diagonally spaced apart from each other, an arrangement in which the first sub-magnet 5110 is eccentrically disposed toward the first guide portion G1, and an arrangement in which the second sub-magnet 5130 is eccentrically disposed toward the second guide portion G2, and by this rotational force, the plurality of first protrusions p1 of the first guide portion G1 and at least one second protrusion p2 of the second guide portion G2 may come into contact with the housing 1100.

Although the rotational force is applied to the carrier 4000, the plurality of first protrusions p1 and at least one second protrusion p2 may be in contact with, and supported by, the housing 1100, thereby preventing a rotation of the carrier 4000, and the carrier 4000 may be supported to move in the optical axis (Z-axis) direction.

The camera module 2 according to another example embodiment may allow the center of the carrier 4000 to be positioned within a region connecting portions supported by the first guide portion G1 and the second guide portion G2 (that is, the region where the carrier 4000 is supported and the center of the carrier 4000 are not spaced apart from each other), and the carrier 4000 may thus move to be parallel to the optical axis (Z-axis)). Therefore, driving stability may be improved during the focus adjustment.

When viewed in the optical axis (Z-axis) direction, an imaginary line connecting vertices of the first protrusion p1 and the second protrusion p2 may have an acute angle with respect to one surface of the first sub-magnet 5110 and one surface of the second sub-magnet 5130, respectively.

When viewed in the optical axis (Z-axis) direction, the imaginary line connecting the vertices of the first protrusion p1 and the second protrusion p2 may form an acute angle with one side surface of the carrier 4000 on which the first sub-magnet 5110 is mounted, and may also form an acute angle with the other side surface of the carrier 4000 on which the second sub-magnet 5130 is mounted.

When viewed in the optical axis (Z-axis) direction, the imaginary line connecting the vertices of the first protrusion p1 and the second protrusion p2 may pass through the lens module 2000. Specifically, the imaginary line connecting the vertices of the first protrusion p1 and the second protrusion p2 may pass through at least one lens accommodated in the lens module 2000.

A length of the imaginary line connecting the vertices of the first protrusion p1 and the second protrusion p2 may be greater than the maximum diameter of the lens barrel 2100.

When viewed in the optical axis (Z-axis) direction, the center of the carrier 4000 (or the center of the lens module 2000) may be positioned within a first region a1 connecting both ends of the first protrusion p1 to both ends of the second protrusion p2.

Additionally, a center 8100a of the image sensor 8100 (or the center of an effective imaging surface of the image sensor 8100) may be positioned within the first region a1.

In an example, when the region connecting both ends of the first sub-magnet 5110 to both ends of the second sub-magnet 5130 is defined as a second region, the center of the carrier 4000 (or the center of the lens module 2000) may be positioned within a region in which the first region a1 and the second region overlap with each other.

Additionally, the center 8100a of the image sensor 8100 (or the center of the effective imaging surface of the image sensor 8100) may be positioned within the region in which the first region a1 and the second region a2 overlap with each other.

In an example, the camera module 2 may detect a position of the carrier 4000 in the optical axis (Z-axis) direction.

Accordingly, a first position sensor 5500 may be provided. The first position sensor 5500 may be disposed on the substrate 7000 to face the first magnet 5100. In an example, the first position sensor 5500 may be a Hall sensor.

The first position sensor 5500 may include two Hall sensors which face the first sub-magnet 5110 and the second sub-magnet 5130.

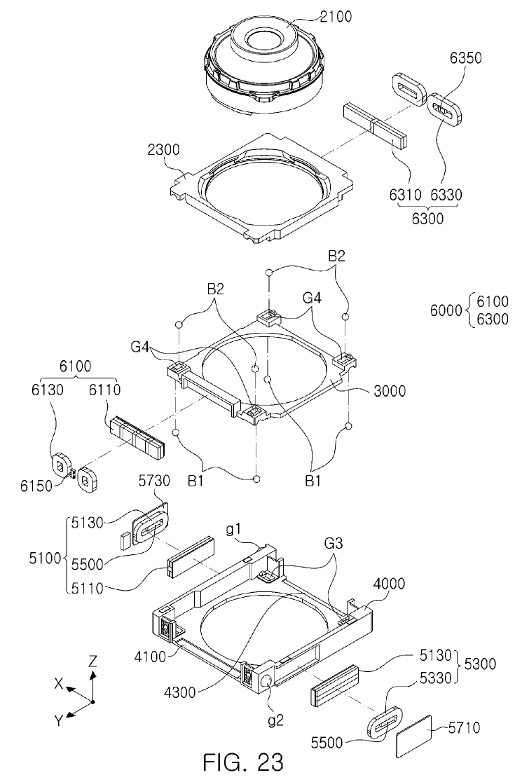

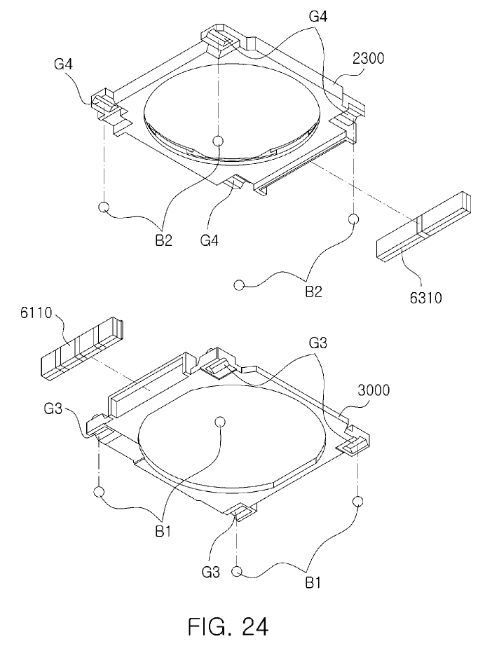

FIG. 23 is an exploded perspective view illustrating a partial configuration of the camera module according to another example embodiment, and FIG. 24 is a bottom perspective view of the lens holder and a guide frame included in the camera module according to another example embodiment.

Referring to FIGS. 23 and 24, the camera module 2 may perform optical image stabilization during image capture by moving the lens module 2000 (2100, 2300) in the direction perpendicular to the optical axis (Z-axis). Accordingly, the camera module 2 may include a second driving unit 6000 that moves the lens module 2000 in the direction perpendicular to the optical axis (Z-axis).

Referring to FIG. 23, a carrier 4000 may sequentially accommodate a guide frame 3000 and the lens module 2000. In an example, the guide frame 3000 may be disposed between the carrier 4000 and the lens module 2000. The guide frame 3000 may have a rectangular plate shape with a hollow portion.

Based on a driving force of the second driving unit 6000, the guide frame 3000 and the lens module 2000 may move together in the first direction (X-direction), and the lens module 2000 may move relative to the guide frame 3000 in the second direction (Y-direction).

The second driving unit 6000 may include a first sub-driving unit 6100 and a second sub-driving unit 6300. The first sub-driving unit 6100 may generate a driving force in the first direction (X-direction), and the second sub-driving unit 6300 may generate a driving force in the second direction (Y-direction).

The first sub-driving unit 6100 may include a second magnet 6110 and a second coil 6130. The second magnet 6110 and the second coil 6130 may be disposed to face each other in the second direction (Y-direction).

The second magnet 6110 may be disposed on the guide frame 3000. In an example, the second magnet 6110 may be mounted on one side surface of the guide frame 3000.

In an example, one surface of the second magnet 6110 may be magnetized to have four poles. For example, one surface of the second magnet 6110 may have N, S, N, and S-poles arranged sequentially along the first direction (X-direction). A neutral region may be formed between the respective N-pole and the S-pole.

The second coil 6130 may be disposed to face the second magnet 6110. For example, the second coil 6130 may be disposed to face the second magnet 6110 in the second direction (Y-direction).

The second coil 6130 may have a donut shape with a hollow portion. The second coil 6130 may include a plurality of coils. For example, the second coil 6130 may include two coils spaced apart from each other in the first direction (X-direction), and each coil may be disposed to face the second magnet 6110.

Additionally, the two coils may be disposed to respectively face the N-pole and the S-pole of the second magnet 6110. That is, one coil may face both the N-pole and the S-pole of the second magnet 6110, and the other coil may also face both the N-pole and the S-pole of the second magnet 6110.

Therefore, the second magnet 6110 and the second coil 6130 may generate a driving force in the first direction (X-direction), which is perpendicular to the direction (i.e., the second direction (Y-direction)) in which the second magnet 6110 and the second coil 6130 face each other.

During optical image stabilization, the second magnet 6110 may be a moving member that is mounted on the lens holder 2300, and the second coil 6130 may be a fixed member that is fixed to the housing 1100.

When power is applied to the second coil 6130, an electromagnetic force generated between the second magnet 6110 and the second coil 6130 may move the lens module 2000 and the guide frame 3000 in the first direction (X-direction).

The second sub-driving unit 6300 may include a third magnet 6310 and a third coil 6330. The third magnet 6310 and the third coil 6330 may be disposed to face each other in the second direction (Y-direction).

The third magnet 6310 may be disposed on the lens module 2000. For example, the third magnet 6310 may be mounted on one side surface of the lens holder 2300.

In an example, one surface of the third magnet 6310 may be magnetized to have two poles. For example, one surface of the third magnet 6310 may have an N-pole and an S-pole disposed sequentially along the first direction (X-direction). A neutral region may be formed between the N-pole and the S-pole.

The third coil 6330 may be disposed to face the third magnet 6310. For example, the third coil 6330 may be disposed to face the third magnet 6310 in the second direction (Y-direction).

The third coil 6330 may have a donut shape with a hollow portion. The third coil 6330 may include a plurality of coils. For example, the third coil 6330 may include two coils that are spaced apart from each other in the first direction (X-direction), and each coil may be disposed to face the third magnet 6310.

Additionally, polarities of respective surfaces of the third magnet 6310 facing the two coils may be different from each other. For example, one of the two coils may face the N-pole of the third magnet 6310, and another one of the two coils may face the S-pole of the third magnet 6310.

Therefore, the third magnet 6310 and the third coil 6330 may generate a driving force in the second direction (Y-direction), which is a direction in which the third magnet 6310 and the third coil 6330 face each other.

The second coil 6130 and the third coil 6330 may be disposed on the substrate 7000. For example, the second coil 6130 and the third coil 6330 may be disposed on the substrate 7000 to face the second magnet 6110 and the third magnet 6310, respectively.

The substrate 7000 may be mounted on a side surface of the housing 1100, and the second coil 6130 and the third coil 6330 may directly face the second magnet 6110 and the third magnet 6310 through openings disposed in the housing 1100.

During optical image stabilization, the third magnet 6310 may be a moving member that is mounted on the lens holder 2300, and the third coil 6330 may be a fixed member that is fixed to the housing 1100.

When power is applied to the third coil 6330, an electromagnetic force generated between the third magnet 6310 and the third coil 6330 may move the lens module 2000 in the second direction (Y-direction).

A first ball member B1 may be disposed between the carrier 4000 and the guide frame 3000, and a second ball member B2 may be disposed between the guide frame 3000 and the lens module 2000.

The configurations of the first ball member B1 and the second ball member B2 are similar to those of the camera module 1 according to an example embodiment described above, and detailed descriptions thereof are thus omitted.

A first guide groove part G3 that accommodates the first ball member B1 may be formed in at least one of surfaces of the carrier 4000 and the guide frame 3000 which face each other in the optical axis (Z-axis) direction. The first guide groove part G3 may include a plurality of guide grooves which correspond to the plurality of balls of the first ball member B1.

A second guide groove part G4 that accommodates the second ball member B2 may be formed in at least one of surfaces of the guide frame 3000 and the lens module 2000 (for example, the lens holder 2300) facing each other in the optical axis (Z-axis) direction. The second guide groove part G4 may include a plurality of guide grooves corresponding to the plurality of balls of the second ball member B2.

In an example embodiment, the camera module 2 may detect a position of the lens module 2000 in the direction perpendicular to the optical axis (Z-axis).

Accordingly, a second position sensor 6150 and a third position sensor 6350 may be provided. The second position sensor 6150 may be disposed on the substrate 7000 to face the second magnet 6110, and the third position sensor 6350 may be disposed on the substrate 7000 to face the third magnet 6310. In an example, the second position sensor 6150 and the third position sensor 6350 may be Hall sensors.

In an example, second and third yokes 4100 and 4300 may be provided to allow the carrier 4000 and the guide frame 3000 to maintain contact with the first ball member B1, and to allow the guide frame 3000 and the lens module 2000 to maintain contact with the second ball member B2.

The second yoke 4100 and the third yoke 4300 may be fixed to the carrier 4000, and may be disposed to face the second magnet 6110 and the third magnet 6310 in the optical axis (Z-axis) direction.

Therefore, attraction forces in the optical axis (Z-axis) direction may be generated between the second yoke 4100 and the second magnet 6110, and between the third yoke 4300 and the third magnet 6310, respectively.

In an example, a stopper 2500 may be coupled to the carrier 4000 to cover at least a portion of an upper surface of the lens module 2000. In an example, the stopper 2500 may cover at least a portion of an upper surface of the lens holder 2300.

The stopper 2500 may prevent the guide frame 3000 and the lens module 2000 from being separated outward from the carrier 4000 due to an external impact or the like.

As set forth above, the camera module according to the example embodiments may have a focus adjustment operation, and may reduce the size of the camera module.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a carrier, accommodated in the housing, and configured to move in an optical axis direction; and
a first guide portion and a second guide portion respectively disposed between the housing and the carrier, and spaced apart from each other in a diagonal direction of the carrier,
wherein the first guide portion is disposed on any one of the carrier and the housing, and comprises a plurality of first protrusions that are spaced apart from each other in the optical axis direction,
wherein the second guide portion comprises at least one second protrusion that is disposed on any one of the carrier and the housing, and
wherein sliding friction occurs on the plurality of first protrusions as the carrier moves.

2. The camera module according to claim 1, wherein sliding friction occurs on the at least one second protrusion as the carrier moves.

3. The camera module according to claim 1, wherein the first guide portion further comprises a first guide groove that is disposed in another of the carrier and the housing, and
wherein each of the plurality of first protrusions is in two-point contact with the first guide groove.

4. The camera module according to claim 3, wherein a guide plate made of a metal material is disposed in the first guide groove, and
wherein each of the plurality of first protrusions is in two-point contact with the guide plate.

5. The camera module according to claim 1, wherein the second guide portion further comprises a second guide groove that is disposed in another of the carrier and the housing, and
wherein the at least one second protrusion is in one-point contact with the second guide groove.

6. The camera module according to claim 1, wherein the first guide portion further comprises a shaft that is disposed on another of the carrier and the housing, and
wherein the shaft is in contact with the plurality of first protrusions.

7. The camera module according to claim 6, wherein a guide plate made of a metal material is disposed on a surface of each of the plurality of first protrusions, and
wherein the shaft is in contact with the guide plate.

8. The camera module according to claim 1, wherein the plurality of first protrusions are bonded to any one of the carrier and the housing.

9. The camera module according to claim 1, further comprising:
a first driving unit comprising a first magnet disposed on a first side surface of the carrier and a first coil disposed to face the first magnet, and
a first yoke disposed to face the first magnet,
wherein the first yoke is disposed closer to the first guide portion than to the second guide portion.

10. The camera module according to claim 9, wherein the plurality of first protrusions protrude from one corner of the carrier, and
wherein the at least one second protrusion protrudes from a second side surface of the carrier adjacent to the first side surface of the carrier.

11. The camera module according to claim 1, further comprising a first driving unit configured to move the carrier in the optical axis direction,
wherein the first driving unit comprises:
a first sub-magnet disposed on a first side surface of the carrier;
a second sub-magnet disposed on a second side surface of the carrier, which is spaced apart from the first side surface of the carrier in a first direction perpendicular to the optical axis direction;
a first sub-coil disposed to face the first sub-magnet; and
a second sub-coil disposed to face the second sub-magnet.

12. The camera module according to claim 11, further comprising:
a first sub-yoke disposed to face the first sub-magnet; and
a second sub-yoke disposed to face the second sub-magnet.

13. The camera module according to claim 12, wherein a center of the first sub-magnet is disposed closer to the first guide portion than to a center of the first side surface of the carrier, and
a center of the second sub-magnet is disposed closer to the second guide portion than to a center of a second side surface of the carrier.

14. The camera module according to claim 13, wherein the center of the first sub-magnet and the center of the second sub-magnet are spaced apart from each other in a second direction perpendicular to both the optical axis direction and the first direction.

15. The camera module according to claim 12, wherein the plurality of first protrusions protrude from the first side surface of the carrier, and
the at least one second protrusion protrudes from the second side surface of the carrier.
